(19) United States
(12) Patent Application Publication
(10) Pub. No.: US 2019/0168341 A1
(43) Pub. Date: Jun. 6, 2019

(54) Method of Manufacturing Tailor Welded Blanks

(71) Applicants: HYUNDAI MOTOR COMPANY, Seoul (KR); KIA Motors Corporation, Seoul (KR)

(72) Inventor: So Youn Kim, Seoul (KR)

(73) Assignees: HYUNDAI MOTOR COMPANY, Seoul (KR); KIA Motors Corporation, Seoul (KR)

(21) Appl. No.: 15/975,135

(22) Filed: May 9, 2018

(30) Foreign Application Priority Data
Dec. 1, 2017 (KR) 10-2017-0163937

(51) Int. Cl. B23K 26/211; B23K 35/30; C22C 38/32; C22C 38/04; C22C 38/02; C22C 38/00; B23K 26/06; B23K 26/067; B23K 26/08; B23K 26/24

(52) U.S. Cl. CPC B23K 26/211; B23K 35/3066; C22C 38/32; C22C 38/04; C22C 38/02; B23K 26/24; B23K 26/0608; B23K 26/0626; B23K 26/0652; B23K 26/0676; B23K 26/0869; C22C 38/002

(57) ABSTRACT

A method of manufacturing tailor welded blanks includes bringing a pair of objects to be welded into contact with each other. The objects are formed of different materials having different thicknesses or strengths. The method further includes adjusting the heat input of a radiated laser beam and dividing the radiated laser beam into a preceding laser beam and a following laser beam in a welding direction using an optical prism. The method further includes forming a welded part by sequentially radiating the preceding laser beam and the following laser beam to the pair of objects to be welded while supplying a filler wire to welded regions of the pair of objects to be welded.

### CROSS-REFERENCE TO RELATED APPLICATION

This application claims the priority benefit of Korean Patent Application No. 10-2017-0163937, filed on Dec. 1, 2017 in the Korean Intellectual Property Office, the disclosure of which is incorporated herein by reference.

### BACKGROUND OF THE DISCLOSURE

### 1. Field of the Disclosure

The present disclosure relates to a method of manufacturing tailor welded blanks by connecting steel sheets having different thicknesses or different materials and, more particularly, to a method of manufacturing tailor welded blanks in which the quality of a welded part may be improved and the manufacturing time of the tailor welded blanks may be shortened when the tailor welded blanks are manufactured using plated steel sheets.

### 2. Description of the Related Art

Recently, as environmental and safety regulations are strengthened, vehicle requirements are continuously strengthened. That is, in order to cope with lightweight requirements for improving fuel efficiency and collision safety, application of high strength steels, for example, including Advanced High Strength Steel (“AHSS”), is increased.

When a vehicle body is manufactured, parts of high strength are applied so as to reinforce rigidity in side collision. Particularly, in case of an electric vehicle, in order to protect a battery, a side collision pillar has a more important role than in a conventional combustion engine vehicle body. For this purpose, use of ultra-high strength steel to which Hot Press Forming (“HPF”) technology is applied is increasing.

Parts applied as collision members are generally divided into two kinds.

As a first kind, there are energy absorption members that absorb impact applied from the outside through deformation.

Representatively, the energy absorption members correspond to a front part of a front side member, a rear part of a rear side member and a lower part of a B-pillar.

As a second kind, there are anti-intrusion members that are scarcely deformed. For example, since a passenger compartment in which passengers are located must be secured when a collision of a vehicle occurs, most collision members applied to the passenger compartment correspond to anti-intrusion members.

Representatively, the anti-intrusion members correspond to a rear part of the front side member, a front part of the rear side member and an upper part of the B-pillar.

Collision performance is improved by applying the HPF technology to anti-intrusion members are rapidly increasing, and applying Advanced High Strength Steel having relatively high elongation to energy absorption members.

An energy absorption member and an anti-intrusion member are coupled to each other by welding and then forming the parts, such as the front side member, the rear side member and the B-pillar.

Here, the tailor welded blanks (“TWB”) method is mainly used. The TWB method involves a series of processes, in which a part is manufactured by cutting steel sheets having different thicknesses, strengths and materials into desired shapes; welding the cut steel sheets and press-forming the welded steel sheets; and generally includes cutting the steel sheets, welding the cut steel sheets with a laser, and blanking the welded steel sheets.

Such a TWB method may produce a member formed by welding steel sheets having different thicknesses or different materials in order to have the characteristics required to manufacture a member having a high rigid structure, a long lifespan and a precise size, as compared to the steel sheets. The resulting members can be applied to the manufacture of structures, such as a vehicle body panel of a vehicle or an electric train.

Particularly, in the automobile industry, high productivity, low cost and low weight are required. In the forming method used to manufacture a structure of a conventional vehicle body panel, a part is manufactured by respectively cutting and forming steel sheets and then spot-welding the steel sheets. When compared to this forming method, the TWB method has a number of advantages, including a decrease in the number of parts, vehicle body weight reduction, manufacturing cost reduction, quality improvement, collision stability improvement and vehicle body structure simplification.

When tailor welded blanks are manufactured using plated steel sheets having Al—Si or Zn plating layers, the plating layers are introduced into a welded part and may thus lower physical properties of the welded part.

Therefore, a technique was developed in which plated steel plates are welded with a laser. The resulting welded part has a full martensite structure using a filler wire. Thus, quality degradation of the welded part is prevented.

In order to form the martensite structure of the welded part, heat input of 30 KJ/m or more of the laser is required. If excessively high heat input of the laser is applied to secure the quality of the welded part, melt-down occurs and may thus cause defects in the welded part.

Therefore, the development of a technique in which sufficient heat input is supplied to a welded part so as to prevent melt-down defects while securing welding quality is required.

The above description has been provided to aid in understanding of the background of the present disclosure and should not be interpreted as conventional technology known to those skilled in the art.

### SUMMARY OF THE DISCLOSURE

Therefore, the present disclosure has been made in view of the above problems, and it is an object of the present disclosure to provide a method of manufacturing tailor welded blanks in which plated steel sheets are welded with a laser using a filler wire so as to improve quality of a welded part while minimizing defects, such as melt-down, etc.

It is another object of the present disclosure to provide a method of manufacturing tailor welded blanks in which plated steel sheets are welded without removal of the plating layers from the plated steel sheets so as to shorten the manufacturing time of the tailor welded blanks and to improve quality of a welded part.

In accordance with the present disclosure, the above and other objects can be accomplished by providing a method of manufacturing tailor welded blanks including bringing a pair of objects to be welded into contact with each other, the pair of objects being formed of different materials having different thicknesses or strengths, adjusting a heat input of a radiated laser beam, and dividing the radiated laser beam into a preceding laser beam and a following laser beam in a welding direction using an optical prism, and forming a welded part by sequentially radiating the preceding laser beam and the following laser beam to the pair of objects to be welded while supplying a filler wire to regions of the pair of objects to be welded.

The division of the laser beam may include dividing the radiated laser beam into the preceding laser beam and the following laser beam using the optical prism so that a heat input of the preceding laser beam is 40-60% of the heat input of the radiated laser beam.

In the adjustment of the heat input, the heat input of the radiated laser beam is 30-130 kJ/m and is calculated by the equation

Q=η(P/v),

wherein Q may indicate heat input (kJ/m), η may indicate an absorption coefficient of the objects to be welded, P may indicate laser beam output (k/w), and v may indicate welding speed (m/min).

In the division of the radiated laser beam, the radiated laser beam may be divided into the preceding laser beam and the following laser beam so that the preceding laser beam and the following laser beam have the same heat input.

In the division of the radiated laser beam, the radiated laser beam may be divided into the preceding laser beam and the following laser beam so that a beam distance between the preceding laser beam and the following laser beam sequentially radiated to the pair of objects to be welded in the welding direction is in the range of approximately 1.12-5 mm.

The pair of objects to be welded may be a pair of plated steel sheets having different thicknesses or strengths and comprise 0.19-0.25 wt % of C, 0.20-0.40 wt % of Si, 1.10-1.60 wt % of Mn, 0.03 wt % or less of P, 0.015 wt % or less of S, 0.10-0.60 wt % of Cr, 0.0008-0.0050 wt % of B, the remainder wt % of Fe and other inevitable impurities, each plated steel sheet having an Al—Si plating layer.

The filler wire may include 0.6-0.9 wt % of C, 0.3-0.9 wt % of Mn, 1.6-3.0 wt % of Ni, the remainder wt % of Fe and other inevitable impurities.

### BRIEF DESCRIPTION OF THE DRAWINGS

The above and other objects, features and other advantages of the present disclosure will be more clearly understood from the following detailed description taken in conjunction with the accompanying drawings, in which:

FIG. 1 is a view illustrating a method of manufacturing tailor welded blanks in accordance with one embodiment of the present disclosure;

FIG. 2 is a view illustrating a distance between beams in accordance with one embodiment of the present disclosure;

FIG. 3 is a photograph illustrating an occurrence of melt-down of a welded part when the heat input exceeds 130 kJ/m;

FIG. 4 is a photograph illustrating the welded part in accordance with one embodiment of the present disclosure;

FIG. 5 is a graph illustrating heat inputs according to laser beam outputs in accordance with various test examples and comparative examples in which different beam distances are set;

FIG. 6 is a graph illustrating heat input according to welding speed;

FIG. 7 is a graph illustrating the relationship between welding speed and welded part width according to beam distance;

FIG. 8 is a table illustrating a cross-section of a welded part and the position of fracture in a tensile test according to a heat input ratio of a preceding laser beam to a following laser beam; and

FIG. 9 illustrates cross-sections and hardnesses of welded parts in accordance with test example 2 of the present disclosure and comparative example 1.

### DETAILED DESCRIPTION OF THE EXEMPLARY EMBODIMENTS

Reference will now be made in detail to the exemplary embodiments of the present disclosure, examples of which are illustrated in the accompanying drawings. Wherever possible, the same reference numbers will be used throughout the drawings to refer to the same or like parts. Contents which are stated in other drawings may be cited, and contents which are judged to be apparent to those skilled in the art or are repeated will be omitted.

The present disclosure is characterized in that one laser beam is divided into a preceding laser beam and a following laser beam. The preceding laser beam melts a pair of objects to be welded, i.e., Al—Si plated steel sheets, and a filler wire. The following laser beam activates agitation of molten regions and thus induces homogenization in the distribution of Al—Si plating layers in a welded part so as to improve quality of the welded part.

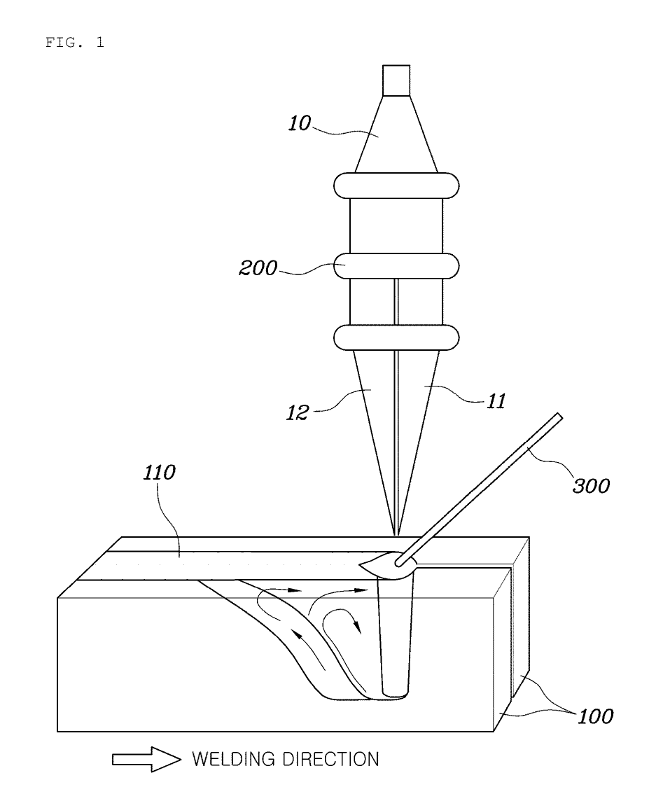

FIG. 1 is a view illustrating a method of manufacturing tailor welded blanks in accordance with one embodiment of the present disclosure.

As exemplarily shown in FIG. 1, a method of manufacturing tailor welded blanks in accordance with one embodiment of the present disclosure includes bringing a pair of objects to be welded 100 into contact with each other; adjusting the heat input of a radiated laser beam 10 and dividing the radiated laser beam 10 into a preceding laser beam 11 and a following laser beam 12; and welding the objects to be welded 100 while supplying a filler wire 300.

In preparation for welding, a pair of objects to be welded 100 is placed in contact with each other. The objects 100 are formed of different materials, at least one of thickness or strength being different.

In the present disclosure, the objects to be welded 100 mainly employ boron steel sheets having hardenability as base materials of tailor welded blanks for hot stamping. Al—Si plating layers are used as plating layers of the objects to be welded 100.

In more detail, the objects to be welded 100 used in the present disclosure include 0.19-0.25 wt % of C; 0.20-0.40 wt % of Si; 1.10-1.60 wt % of Mn; 0.03 wt % or less of P; 0.015 wt % or less of S; 0.10-0.60 wt % of Cr; 0.0008-0.0050 wt % of B; and the remainder wt % of Fe and other inevitable impurities. The plating layers of the objects to be welded 100 include Al—Si.

In the method in accordance with one embodiment of the present disclosure, the filler wire 300 may be used during laser welding. Thus, the components of the welded part 110 are adjusted so that the welded part 100 has a full austenite structure at a temperature of 900-950 r.

By transforming the welded part 110 to a full martensite structure through quenching after hot stamping, the strength of the welded part 110 may be improved so that the welded part 110 has the desired physical properties.

Therefore, the filler wire 300 used in the present disclosure may include C, Mn and Ni as austenite stabilizing elements, which lower a eutectoid temperature Ac3 as contents thereof are increased. In more detail, the filler wire 300 includes 0.6-0.9 wt % of C, 0.3-0.9 wt % of Mn, 1.6-3.0 wt % of Ni, and the remainder wt % of Fe and other inevitable impurities. Thus, the filler wire 300 transforms the welded part 110 to the full austenite structure at a temperature of 900-950 r, even though the plating layers of the objects to be welded 100 are introduced into the welded part 110.

The reason for this is as follows. If the content of C is less than 0.6 wt %, the rate of increase of an austenite region is low and the austenite and ferrite structures coexist in the welded part 110 at a temperature of 900-950 r during welding. If the content of C exceeds 0.9 wt %, the hardness and strength of the welded part 110 are increased and fracture of the welded part 110 is caused when an impact, such as collision, occurs.

Further, if the contents of Mn and Ni deviate from the above ranges, the welded part 110 does not have the full austenite structure at a temperature of 900-950° C. The physical properties of the welded part 110 of a product completed after hot stamping are changed. Thus, defects such as fracture of the welded part 110 are caused. Therefore, the contents of C, Mn and Ni are restricted to the above-described ranges.

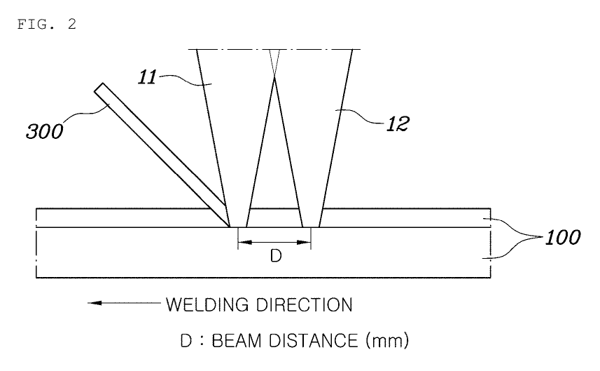

FIG. 2 is a view illustrating a distance between beams in accordance with one embodiment of the present disclosure.

As exemplarily shown in FIG. 2, when preparation for welding is completed, the heat input of the radiated laser beam 10 is adjusted and the radiated laser beam 10 is divided into the preceding laser beam 11 and the following laser beam 12 using an optical prism.

In more detail, the adjustment of the heat input of the radiated laser beam 10 and the division of the radiated laser beam 10 in accordance with one embodiment of the present disclosure include adjusting the heat input of the radiated laser beam 10 and dividing the radiated laser beam 10. The heat input of the radiated laser beam 10 is adjusted according to the physical properties of the objects to be welded 100, such as thicknesses, materials, etc. The radiated laser beam 10 is divided into the preceding laser beam 11 and the following laser beam 12 using the optical prism 200 and the heat input is adjusted.

The heat input of the radiated laser beam 10, calculated by Equation 1 below, may be adjusted to be 30-130 kJ/m.

Q=η(P/v) [Equation 1]

Here, Q indicates heat input (kJ/m), η indicates an absorption coefficient of the objects to be welded 100, P indicates laser beam output (k/w), and v indicates welding speed (m/min).

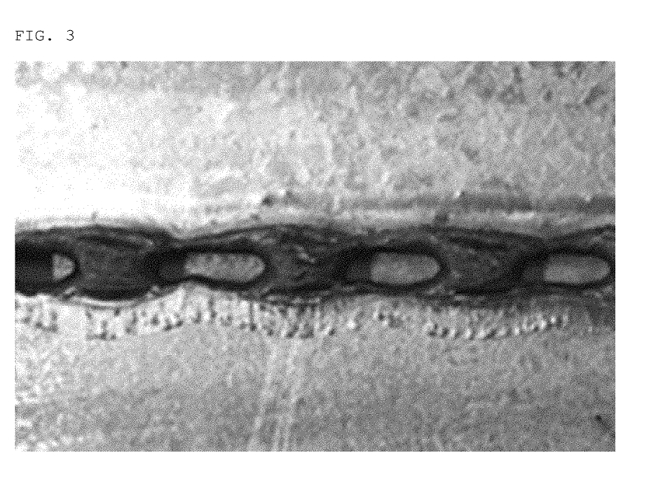

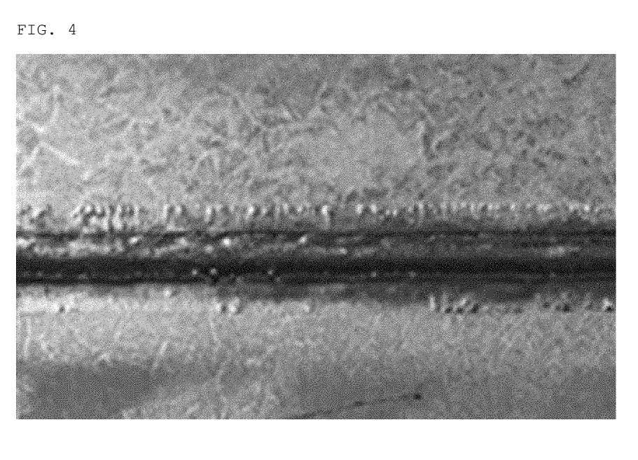

FIG. 3 is a photograph illustrating an occurrence of melt-down of the welded part when the heat input exceeds 130 kJ/m, and FIG. 4 is a photograph illustrating a welded part in accordance with one embodiment of the present disclosure.

As exemplarily shown in FIGS. 3 and 4, if the heat input exceeds 130 kJ/m, the objects to be welded 100 and the filler wire 300 are excessively melted and thus melt-down occurs. If the heat input is less than 30 kJ/m, a long time is taken to perform welding and welding is not effectively carried out. Therefore, the heat input of the radiated laser beam 10 is restricted to the above-described range.

If the heat input satisfies the above-described range, the occurrence of defects, such as melt-down, is minimized and, thus, the welded part 110 having excellent quality may be formed.

When the adjustment of the heat input is completed, the radiated laser beam 10 is divided into the preceding laser beam 11 and the following laser beam 12 in a welding direction using the optical prism 200.

Here, a beam distance D between the preceding laser beam 11 and the following laser beam 12 may be in the range of approximately 1.12-5.0 mm.

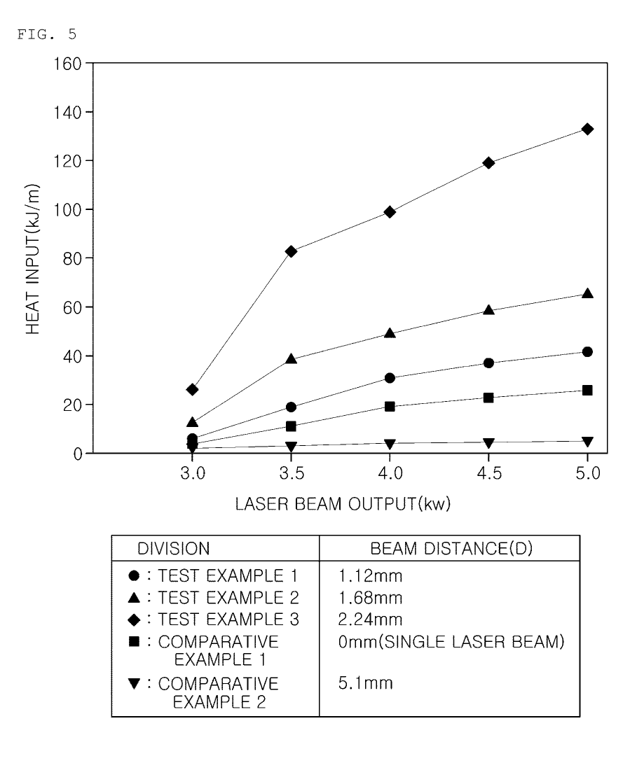

FIG. 5 is a graph illustrating heat inputs according to laser beam outputs in accordance with various test examples and comparative examples in which different beam distances are set.

As exemplarily shown in FIG. 5, if the beam distance D is less than 1.12 mm or exceeds 5.0 mm, even when the radiated laser beam 10 having the same output is used, heat input is low and thus it is difficult to secure welding quality. If the beam distance D satisfies the above-described range, welding quality may be secured at a low output, as compared to comparative example 1 in which a single laser beam is used and comparative example 2 in which the beam distance D exceeds 5.0 mm. Thus, manufacturing costs may be reduced and productivity may be improved.

More particularly, in the division of the radiated laser beam 10 in accordance with one embodiment of the present disclosure, the radiated laser beam 10 may be divided into the preceding laser beam 11 and the following laser beam 12 so that the heat input of the preceding layer beam 11 is 40-60% of the heat input of the radiated laser beam 10.

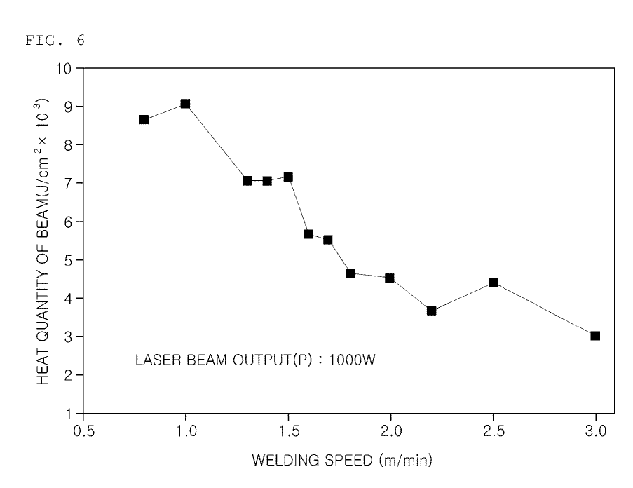

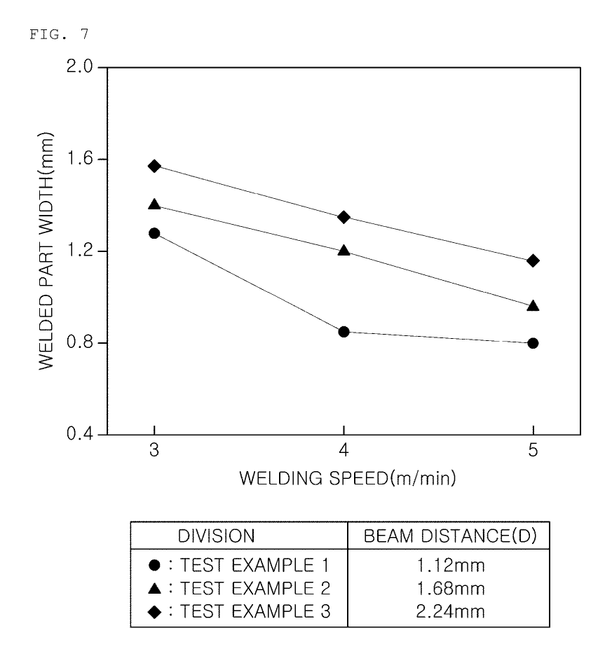

FIG. 6 is a graph illustrating heat input according to welding speed, and FIG. 7 is a graph illustrating the relationship between welding speed and welded part width according to beam distance.

As known from FIGS. 6 and 7, when the output of the radiated laser beam 10 is constant, the heat input is gradually increased as the welding speed is decreased. When the output of the radiated laser beam 10 and the welding speed are constant, the heat input is gradually increased. Thus, the width of the welded part 110 is increased as the beam distance D is increased.

The reason for this is that the heat input is increased as a cooling speed is decreased in the test examples of the present disclosure, as compared to the case that a single laser beam is used. It may be confirmed that the cooling speed in comparative example 1, in which a single laser beam is used, is 1004° C./s and the cooling speed in comparative example 2 is remarkably decreased to 570° C./s.

More particularly, in the division of the radiated laser beam 10 in accordance with one embodiment of the present disclosure, the radiated laser beam 10 may be divided into the preceding laser beam 11 and the following laser beam 12 so that the heat input of the preceding layer beam 11 is 50% of the heat input of the radiated laser beam 10.

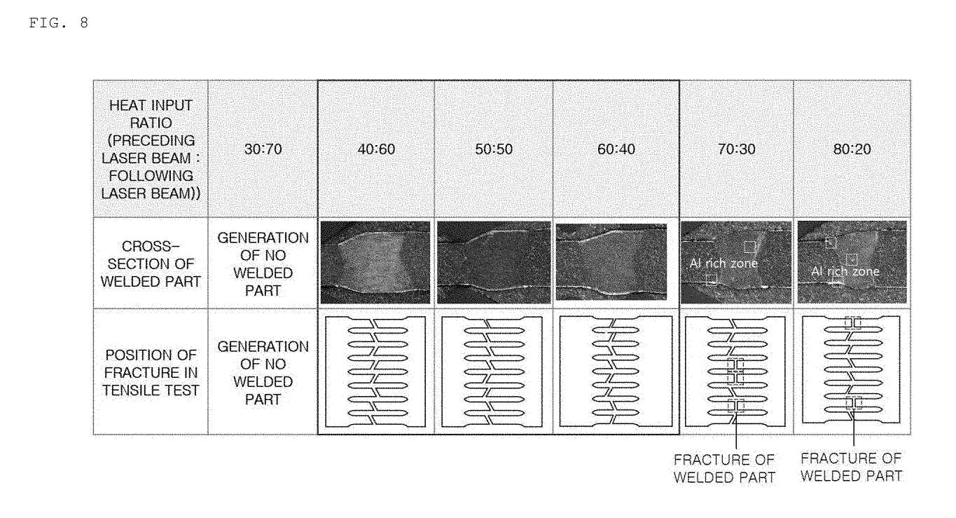

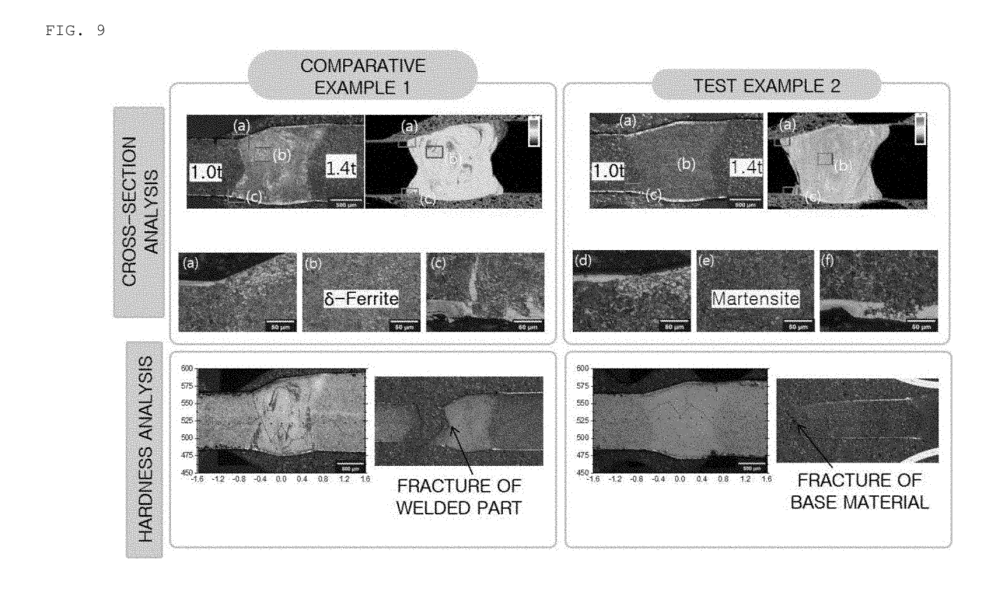

FIG. 8 is a table illustrating a cross-section of a welded part and the position of fracture in a tensile test according to a heat input ratio of a preceding laser beam to a following laser beam, and FIG. 9 is a view illustrating cross-sections and hardnesses of welded parts in accordance with test example 2 of the present disclosure and comparative example 1.

As exemplarily shown in FIG. 8, if a ratio of the heat input of the preceding laser beam 11 to the overall heat input of the radiated laser beam 10 is less than 40%, the heat input of the preceding laser beam 11 is low and, thus, the objects to be welded 100 and the filler wire 300 are not melted and welding is not effectively carried out. If the ratio of the heat input of the preceding laser beam 11 to the overall heat input of the radiated laser beam 10 exceeds 60%, the heat input of the following laser beam 12 is relatively low. Thus, agitation of the Al—Si plating layers is not effectively carried out and causes segregation of the plating layers, thereby causing fracture of the welded part 100.

As known from FIG. 9, in comparative example 1 in which a single laser beam is used, segregation of the plating layers occurs and a ferrite phase is formed in some regions. In test example 2 of the present disclosure, however, the following laser beam 12 activates agitation of the welded part 110 and thus facilitates homogenization in the distribution of the plating layers without segregation of the plating layers, and a martensite structure is secured. Thus, the physical properties of the welded part 100 may be improved, as compared to a conventional method.

Further, it may be confirmed from hardness analysis that, in comparative example 1, the components of the Al—Si plating layers are concentrated in some regions of the welded part 110 and thus cause fracture of the welded part 110. In test example 2, however, the components of the Al—Si plating layers are uniformly distributed throughout the welded part 110 and thus do not cause fracture of the welded part 110 and cause fracture of the objects to be welded 100.

As is apparent from the above description, in a method of manufacturing tailor welded blanks in accordance with one embodiment of the present disclosure, when laser welding is carried out to manufacture the tailor welded blanks, removal of plating layers and re-plating are not required and, thus, manufacturing time may be shortened, productivity may be improved and manufacturing costs may be reduced.

Further, the resulting welded part has a full martensite structure and, thus, quality of the welded part may be improved and defects of the welded part, such as melt-down, may be minimized.

Further, the plating layers are uniformly distributed in the welded part and may thus induce homogenization of the welded part and improve quality of the welded part.

Although the preferred embodiments of the present disclosure have been disclosed for illustrative purposes, those skilled in the art will appreciate that various modifications, additions and substitutions are possible, without departing from the scope and spirit of the disclosure as disclosed in the accompanying claims.

What is claimed is:

1. A method of manufacturing tailor welded blanks, comprising:
bringing a pair of objects to be welded into contact with each other, the pair of objects being formed of different materials having different thicknesses or strengths;
adjusting a heat input of a radiated laser beam, and dividing the radiated laser beam into a preceding laser beam and a following laser beam in a welding direction using an optical prism; and
forming a welded part by sequentially radiating the preceding laser beam and the following laser beam to the pair of objects to be welded while supplying a filler wire to regions of the pair of objects to be welded.

2. The method according to claim 1, wherein the division of the radiated laser beam further comprises:
dividing the radiated laser beam into the preceding laser beam and the following laser beam using the optical prism so that a heat input of the preceding laser beam is 40-60% of the heat input of the radiated laser beam.

3. The method according to claim 1, wherein, in the adjustment of the heat input, the heat input of the radiated laser beam is 30-130 kJ/m and is calculated by the equation Q=η(P/v),
wherein, Q indicates heat input (kJ/m), η indicates an absorption coefficient of the objects to be welded, P indicates laser beam output (k/w), and v indicates welding speed (m/min).

4. The method according to claim 2, wherein, in the division of the radiated laser beam, the radiated laser beam is divided into the preceding laser beam and the following laser beam so that the preceding laser beam and the following laser beam have the same heat input.

5. The method according to claim 2, wherein, in the division of the radiated laser beam, the radiated laser beam is divided into the preceding laser beam and the following laser beam so that a beam distance between the preceding laser beam and the following laser beam sequentially radiated to the pair of objects to be welded in the welding direction is in the range of approximately 1.12-5 mm.

6. The method according to claim 1, wherein the pair of objects to be welded are plated steel sheets having different thicknesses or strengths and comprise 0.19-0.25 wt % of C, 0.20-0.40 wt % of Si, 1.10-1.60 wt % of Mn, 0.03 wt % or less of P, 0.015 wt % or less of S, 0.10-0.60 wt % of Cr, 0.0008-0.0050 wt % of B, the remainder wt % of Fe and other inevitable impurities, each plated steel sheet having an Al—Si plating layer.

7. The method according to claim 6, wherein the filler wire includes 0.6-0.9 wt % of C, 0.3-0.9 wt % of Mn, 1.6-3.0 wt % of Ni, the remainder wt % of Fe and other inevitable impurities.
